(19) United States
(12) Patent Application Publication
(10) Pub. No.: US 2019/0373589 A1
(43) Pub. Date: Dec. 5, 2019

(54) METHOD AND TERMINAL FOR DECODING DOWNLINK CONTROL INFORMATION ACCORDING TO MULTI-AGGREGATION LEVEL

(71) Applicant: LG ELECTRONICS INC., Seoul (KR)

(72) Inventors: Seunggye HWANG, Seoul (KR); Kijun KIM, Seoul (KR); Byounghoon KIM, Seoul (KR); Bonghoe KIM, Seoul (KR); Joonkui AHN, Seoul (KR); Yunjung YI, Seoul (KR)

(73) Assignee: LG ELECTRONICS INC., Seoul (KR)

(21) Appl. No.: 16/470,185

(22) PCT Filed: Dec. 13, 2017
(86) PCT No.: PCT/KR2017/014612

§ 371 Date: Jun. 14, 2019

Related U.S. Application Data
(60) Provisional application No. 62/435,071, filed on Dec. 15, 2016.
(60) Provisional application No. 62/435,070, filed on Dec. 15, 2016.

(51) Int. Cl. H04W 72/04

(52) U.S. Cl. CPC H04W 72/042

(57) ABSTRACT

Disclosed in the present specification is a method for decoding downlink control information. The method can comprise the steps of: selecting a minimum number, of control channel elements (CCEs), suitable for a current channel situation in an aggregation level defining the number of CCEs of a control channel in which the downlink control information is encoded; determining a frozen bit location and an unfrozen bit location of a polar code in the selected minimum number of CCEs; and performing first decoding of the polar code for the downlink control information encoded in the unfrozen bits.

### BACKGROUND OF THE INVENTION

### Field of the Invention

The present invention relates to mobile communication.

### Related Art

3rd generation partnership project (3GPP) long term evolution (LTE) evolved from a universal mobile telecommunications system (UMTS) is introduced as the 3GPP release 8. The 3GPP LTE uses orthogonal frequency division multiple access (OFDMA) in a downlink, and uses single carrier-frequency division multiple access (SC-FDMA) in an uplink. The 3GPP LTE employs multiple input multiple output (MIMO) having up to four antennas. In recent years, there is an ongoing discussion on 3GPP LTE-advanced (LTE-A) evolved from the 3GPP LTE.

As disclosed in 3GPP TS 36.211 V10.4.0 (2011 December) “Evolved Universal Terrestrial Radio Access (E-UTRA); Physical Channels and Modulation (Release 10)”, a physical channel of LTE may be classified into a downlink channel, i.e., a PDSCH (Physical Downlink Shared Channel) and a PDCCH (Physical Downlink Control Channel), and an uplink channel, i.e., a PUSCH (Physical Uplink Shared Channel) and a PUCCH (Physical Uplink Control Channel).

An Aggregation Level (AL) represents the number of Control Channel Elements (CCEs) used for transmission of a specific PDCCH by a base station and may be determined according to channel conditions. From the standpoint of a UE, it should be able to use the whole range of the AL used by the base station or select part of the ALs. Therefore, in order for a UE to take an AL to be used for decoding selectively from among the ALs transmitted by a base station, it is necessary that only a few ALs are used for successful decoding. However, up to now, it has been reported that no methods were effective to allow decoding to be performed successfully with only a few ALs.

### SUMMARY OF THE INVENTION

Accordingly, a disclosure of the present specification has been made in an effort to solve the aforementioned problem.

To achieve the objective above, a disclosure of the present specification provides a method for decoding downlink control information. The method may comprise selecting a minimum number of Control Channel Elements (CCEs) suitable for a current channel situation in an Aggregation Level (AL) defining the number of CCEs of a control channel in which downlink control information is encoded; determining a frozen bit location and an unfrozen bit location of a polar code in the selected minimum number of CCEs; and performing first decoding of the polar code for the downlink control information encoded in the unfrozen bits.

The method may further comprise selecting a larger number of CCEs than the minimum number if the first decoding fails; determining a frozen bit location and an unfrozen bit location of a polar code on the selected number of CCEs; and performing second decoding of a polar code on the downlink control information encoded on the determined unfrozen bit location.

If the selected minimum number is 1, the frozen bit location and the unfrozen bit location of the polar code on the one CCE may be determined. If the decoding fails and two CCEs, which is larger than the minimum number, 1, are selected, the frozen bit locations and the unfrozen bit locations of the polar code on the two CCEs may be determined.

A set of unfrozen bit locations on the two CCEs may not include a set of unfrozen bit locations on the one CCE.

The method may further comprise performing a parity check on a result of performing the first decoding by using a result of performing the second decoding.

The method may further comprise combining a result of performing the first decoding and a result of performing the second decoding according to a Log-Likelihood Ratio (LLR) scheme.

To achieve the objective above, a disclosure of the present specification provides a UE for decoding downlink control information. The UE may comprise a transceiver; and a processor controlling the transceiver. The processor may be configured to select a minimum number of Control Channel Elements (CCEs) suitable for a current channel situation in an Aggregation Level (AL) defining the number of CCEs of a control channel in which downlink control information is encoded; determine a frozen bit location and an unfrozen bit location of a polar code in the selected minimum number of CCEs; and perform first decoding of the polar code for the downlink control information encoded in the unfrozen bits.

According to the disclosure of the present invention, the problem of the conventional technology described above may be solved.

### BRIEF DESCRIPTION OF THE DRAWINGS

FIG. 1 is a wireless communication system.

FIG. 2 illustrates a structure of a radio frame according to FDD in 3GPP LTE.

FIG. 3 illustrates an example of resource mapping of a PDCCH.

FIG. 4 illustrates an example of monitoring of a PDCCH.

FIG. 5A illustrates an example of IoT (Internet of Things) communication.

FIG. 5B is an illustration of cell coverage expansion or augmentation for an IoT device.

FIGS. 6A and 6B are diagrams illustrating examples of sub-bands in which IoT devices operate.

FIG. 7 illustrates an example of time resources that can be used for NB-IoT in M-frame units.

FIG. 8 is another illustration representing time resources and frequency resources that can be used for NB IoT.

FIG. 9 illustrates an example of a subframe type in NR.

FIG. 10A illustrates a basic concept of a polar code, and FIG. 10B illustrates a structure of an SC decoder.

FIG. 11 illustrates an encoder structure of a polar code according to a first disclosure of the present specification.

FIG. 12 illustrates a method for generating a CCE of a PDCCH when AL=4.

FIGS. 13A to 13D illustrate a decoding process which varies according to the number of CCEs used by a decoder of a receiver is changed.

FIG. 14 is a flow diagram illustrating a decoding method of a receiver according to a second disclosure.

FIG. 15 illustrates a block diagram of a wireless communication system in which a disclosure of the present specification is implemented.

### DESCRIPTION OF EXEMPLARY EMBODIMENTS

Hereinafter, based on 3rd Generation Partnership Project (3GPP) long term evolution (LTE) or 3GPP LTE-advanced (LTE-A), the present invention will be applied. This is just an example, and the present invention may be applied to various wireless communication systems. Hereinafter, LTE includes LTE and/or LTE-A.

The technical terms used herein are used to merely describe specific embodiments and should not be construed as limiting the present invention. Further, the technical terms used herein should be, unless defined otherwise, interpreted as having meanings generally understood by those skilled in the art but not too broadly or too narrowly. Further, the technical terms used herein, which are determined not to exactly represent the spirit of the invention, should be replaced by or understood by such technical terms as being able to be exactly understood by those skilled in the art. Further, the general terms used herein should be interpreted in the context as defined in the dictionary, but not in an excessively narrowed manner.

The expression of the singular number in the present invention includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the present invention, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present invention.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present invention will be described in greater detail with reference to the accompanying drawings. In describing the present invention, for ease of understanding, the same reference numerals are used to denote the same components throughout the drawings, and repetitive description on the same components will be omitted. Detailed description on well-known arts which are determined to make the gist of the invention unclear will be omitted. The accompanying drawings are provided to merely make the spirit of the invention readily understood, but not should be intended to be limiting of the invention. It should be understood that the spirit of the invention may be expanded to its modifications, replacements or equivalents in addition to what is shown in the drawings.

As used herein, ‘base station’ generally refers to a fixed station that communicates with a wireless device and may be denoted by other terms such as eNB (evolved-NodeB), BTS (base transceiver system), or access point.

As used herein, ‘user equipment (UE)’ may be stationary or mobile, and may be denoted by other terms such as device, wireless device, terminal, MS (mobile station), UT (user terminal), SS (subscriber station), MT (mobile terminal) and etc.

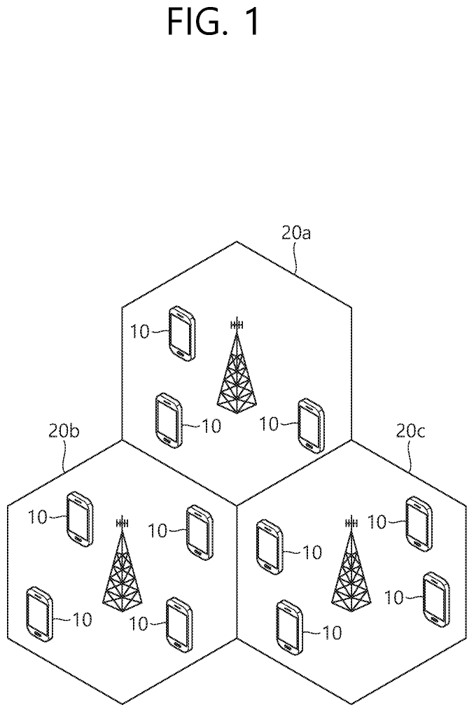

FIG. 1 illustrates a wireless communication system.

As seen with reference to FIG. 1, the wireless communication system includes at least one base station (BS) 20. Each base station 20 provides a communication service to specific geographical areas (generally, referred to as cells) 20a, 20b, and 20c. The cell can be further divided into a plurality of areas (sectors).

The UE generally belongs to one cell and the cell to which the UE belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the UE.

Hereinafter, a downlink means communication from the base station 20 to the UE1 10 and an uplink means communication from the UE 10 to the base station 20. In the downlink, a transmitter may be a part of the base station 20 and a receiver may be a part of the UE 10. In the uplink, the transmitter may be a part of the UE 10 and the receiver may be a part of the base station 20.

Meanwhile, the wireless communication system may be generally divided into a frequency division duplex (FDD) type and a time division duplex (TDD) type. According to the FDD type, uplink transmission and downlink transmission are achieved while occupying different frequency bands. According to the TDD type, the uplink transmission and the downlink transmission are achieved at different time while occupying the same frequency band. A channel response of the TDD type is substantially reciprocal. This means that a downlink channel response and an uplink channel response are approximately the same as each other in a given frequency area. Accordingly, in the TDD based wireless communication system, the downlink channel response may be acquired from the uplink channel response. In the TDD type, since an entire frequency band is time-divided in the uplink transmission and the downlink transmission, the downlink transmission by the base station and the uplink transmission by the terminal may not be performed simultaneously. In the TDD system in which the uplink transmission and the downlink transmission are divided by the unit of a subframe, the uplink transmission and the downlink transmission are performed in different subframes.

Hereinafter, the LTE system will be described in detail.

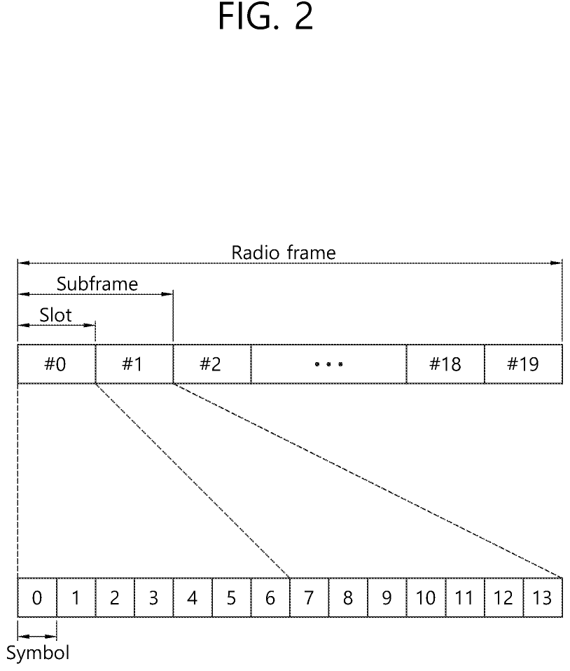

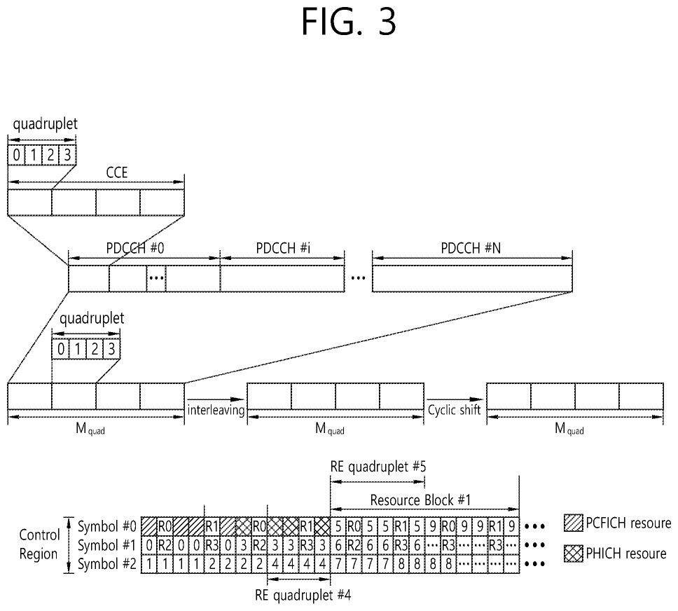

FIG. 2 shows a downlink radio frame structure according to FDD of 3rd generation partnership project (3GPP) long term evolution (LTE).

The radio frame includes 10 sub-frames indexed 0 to 9. One sub-frame includes two consecutive slots. Accordingly, the radio frame includes 20 slots. The time taken for one sub-frame to be transmitted is denoted TTI (transmission time interval). For example, the length of one sub-frame may be 1 ms, and the length of one slot may be 0.5 ms.

The structure of the radio frame is for exemplary purposes only, and thus the number of sub-frames included in the radio frame or the number of slots included in the sub-frame may change variously.

Meanwhile, one slot may include a plurality of OFDM symbols. The number of OFDM symbols included in one slot may vary depending on a cyclic prefix (CP).

One slot includes NRB resource blocks (RBs) in the frequency domain. For example, in the LTE system, the number of resource blocks (RBs), i.e., NRB, may be one from 6 to 110.

The resource block is a unit of resource allocation and includes a plurality of sub-carriers in the frequency domain. For example, if one slot includes seven OFDM symbols in the time domain and the resource block includes 12 sub-carriers in the frequency domain, one resource block may include 7×12 resource elements (REs).

The physical channels in 3GPP LTE may be classified into data channels such as PDSCH (physical downlink shared channel) and PUSCH (physical uplink shared channel) and control channels such as PDCCH (physical downlink control channel), PCFICH (physical control format indicator channel), PHICH (physical hybrid-ARQ indicator channel) and PUCCH (physical uplink control channel).

The uplink channels include a PUSCH, a PUCCH, an SRS (Sounding Reference Signal), and a PRACH (physical random access channel).

<Downlink Control Channel, e.g., PDCCH>

The control information transmitted through the PDCCH is denoted downlink control information (DCI). The DCI may include resource allocation of PDSCH (this is also referred to as DL (downlink) grant), resource allocation of PUSCH (this is also referred to as UL (uplink) grant), a set of transmission power control commands for individual UEs in some UE group, and/or activation of VoIP (Voice over Internet Protocol).

The base station determines a PDCCH format according to the DCI to be sent to the terminal and adds a CRC (cyclic redundancy check) to control information. The CRC is masked with a unique identifier (RNTI; radio network temporary identifier) depending on the owner or purpose of the PDCCH. In case the PDCCH is for a specific terminal, the terminal's unique identifier, such as C-RNTI (cell-RNTI), may be masked to the CRC. Or, if the PDCCH is for a paging message, a paging indicator, for example, P-RNTI (paging-RNTI) may be masked to the CRC. If the PDCCH is for a system information block (SIB), a system information identifier, SI-RNTI (system information-RNTI), may be masked to the CRC. In order to indicate a random access response that is a response to the terminal's transmission of a random access preamble, an RA-RNTI (random access-RNTI) may be masked to the CRC.

In 3GPP LTE, blind decoding is used for detecting a PDCCH. The blind decoding is a scheme of identifying whether a PDCCH is its own control channel by demasking a desired identifier to the CRC (cyclic redundancy check) of a received PDCCH (this is referred to as candidate PDCCH) and checking a CRC error. The base station determines a PDCCH format according to the DCI to be sent to the wireless device, then adds a CRC to the DCI, and masks a unique identifier (this is referred to as RNTI (radio network temporary identifier) to the CRC depending on the owner or purpose of the PDCCH.

FIG. 3 illustrates an example of resource mapping of a PDCCH.

R0 denotes a reference signal of a 1st antenna, R1 denotes a reference signal of a 2nd antenna, R2 denotes a reference signal of a 3rd antenna, and R3 denotes a reference signal of a 4th antenna.

A control region in a subframe includes a plurality of control channel elements (CCEs). The CCE is a logical allocation unit used to provide the PDCCH with a coding rate depending on a state of a radio channel, and corresponds to a plurality of resource element groups (REGs). The REG includes a plurality of resource elements (REs). According to the relationship between the number of CCEs and the coding rate provided by the CCEs, a PDCCH format and a possible PDCCH bit number are determined.

A BS determines the number of CCEs used in transmission of the PDCCH according to a channel state. For example, a UE having a good DL channel state may use one CCE in PDCCH transmission. A UE having a poor DL channel state may use 8 CCEs in PDCCH transmission.

One REG (indicated by a quadruplet in the drawing) includes 4 REs. One CCE includes 9 REGs. The number of CCEs used to configure one PDCCH may be selected from {1, 2, 4, 8}. Each element of {1, 2, 4, 8} is referred to as a CCE aggregation level.

A control channel consisting of one or more CCEs performs interleaving in unit of REG, and is mapped to a physical resource after performing cyclic shift based on a cell identifier (ID).

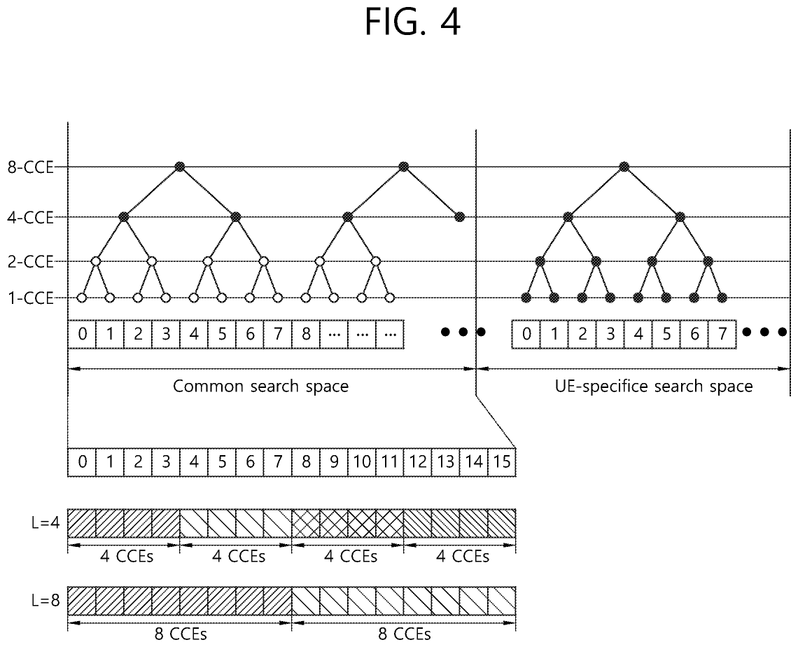

FIG. 4 illustrates an example of monitoring of a PDCCH.

A UE cannot know about a specific position in a control region in which its PDCCH is transmitted and about a specific CCE aggregation or DCI format used for transmission. A plurality of PDCCHs can be transmitted in one subframe, and thus the UE monitors the plurality of PDCCHs in every subframe. Herein, monitoring is an operation of attempting PDCCH decoding by the UE according to a PDCCH format.

The 3GPP LTE uses a search space to reduce an overhead of blind decoding. The search space can also be called a monitoring set of a CCE for the PDCCH. The UE monitors the PDCCH in the search space.

The search space is classified into a common search space and a UE-specific search space. The common search space is a space for searching for a PDCCH having common control information and consists of 16 CCEs indexed with 0 to 15. The common search space supports a PDCCH having a CCE aggregation level of {4, 8}. However, a PDCCH (e.g., DCI formats 0, 1A) for carrying UE-specific information can also be transmitted in the common search space. The UE-specific search space supports a PDCCH having a CCE aggregation level of {1, 2, 4, 8}.

Table 2 below shows the number of PDCCH candidates monitored by a wireless device.

TABLE 2

| | | | Number M^{(L)} |
|---|---|---|---|
| Search space Sₖ^{(L)} | | | of PDCCH |
| Type | Aggregation level L | Size [in CCEs] | candidates |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

A size of the search space is determined by Table 2 above, and a start point of the search space is defined differently in the common search space and the UE-specific search space. Although a start point of the common search space is fixed irrespective of a subframe, a start point of the UE-specific search space may vary in every subframe according to a UE identifier (e.g., C-RNTI), a CCE aggregation level, and/or a slot number in a radio frame. If the start point of the UE-specific search space exists in the common search space, the UE-specific search space and the common search space may overlap with each other.

In a CCE aggregation level L∈{1,2,3,4}, a search space Sₖ^{(L)} is defined as a set of PDCCH candidates. A CCE corresponding to a PDCCH candidate m of the search space Sₖ^{(L)} is given by Equation 1 below.

L{(Yₖ+m′)mod └N_{CCE,k}/L┘}+i [Equation 1]

Herein, I=0, 1, . . . , L−1, m=0, . . . , M^{(L)}−1, and N_{CEE,k} denotes the total number of CCEs that can be used for PDCCH transmission in a control region of a subframe k. The control region includes a set of CCEs numbered from 0 to N_{CCE,k}−1. M^{(L)} denotes the number of PDCCH candidates in a CCE aggregation level L of a given search space.

If a carrier indicator field (CIF) is configured for the wireless device, m′=m+M^{(L)}n_{cif}. Herein, n_{cif} is a value of the CIF. If the CIF is not configured for the wireless device, m′=m.

In a common search space, Yₖ is set to 0 with respect to two aggregation levels L=4 and L=8.

In a UE-specific search space of the aggregation level L, a variable Yₖ is defined by Equation 2 below.

Yₖ=(A·Yₖ₋₁)mod D [Equation 2]

Herein, Y₋₁=n_{RNTI} ≠0, A=39827, D=65537, k=floor(nₛ/2), and nₛ denotes a slot number in a radio frame.

<IoT (Internet of Things) Communication>

Hereinafter, the IoT will be described.

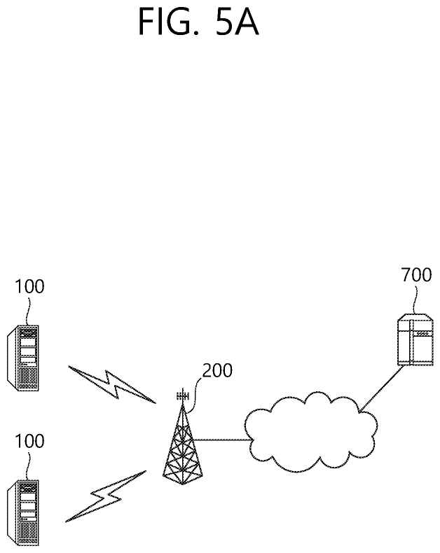

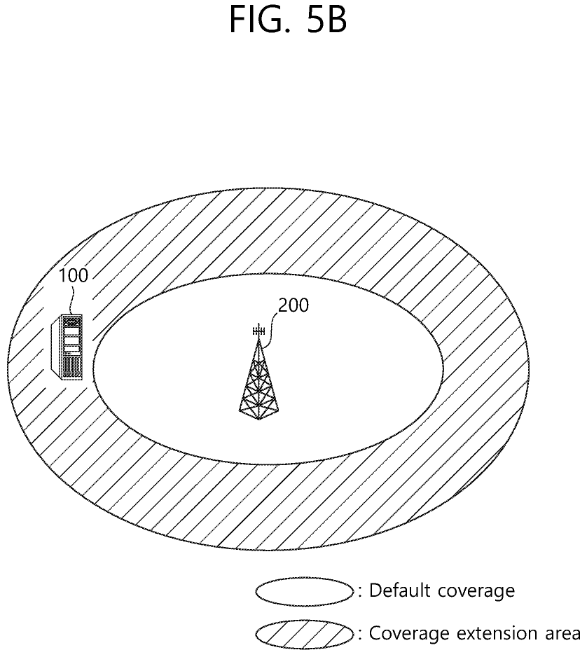

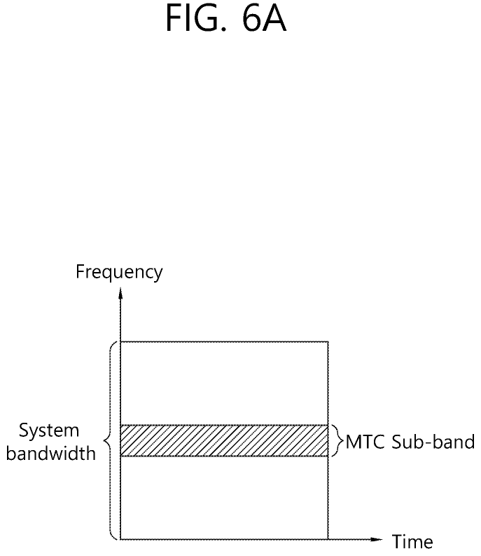

FIG. 5A illustrates an example of IoT (Internet of Things) communication.

The IoT refers to information exchange between the IoT devices 100 without human interaction through the base station 200 or information exchange between the IoT device 100 and the server 700 through the base station 200. In this way, the IoT communication may be also referred to as Cellular Internet of Things (CIoT) in that it communicates with a cellular base station.

Such IoT communication is a type of MTC (machine type communication). Therefore, the IoT device may be referred to as an MTC device.

The IoT service is distinct from the service in the conventional human intervention communication and may include various categories of services such as tracking, metering, payment, medical service, and remote control. For example, the IoT services may include meter reading, water level measurement, use of surveillance cameras, inventory reporting of vending machines, and so on.

Since the IoT communication has a small amount of data to be transmitted and uplink or downlink data transmission and reception rarely occur, it is desirable to lower the cost of the IoT device 100 and reduce battery consumption depending on a low data rate. Further, since the IoT device 100 has low mobility characteristics, the IoT device 100 has characteristics that the channel environment changes little.

FIG. 5B is an illustration of cell coverage expansion or augmentation for an IoT device.

Recently, expanding or augmenting the cell coverage of the base station for the IoT device 100 has been considered, and various techniques for expanding or increasing the cell coverage have been discussed.

However, when the coverage of the cell is expanded or increased, if the base station transmits a downlink channel to the IoT device located in the coverage extension (CE) or coverage enhancement (CE) region, then the IoT device has difficulty in receiving it. Similarly, when an IoT device located in the CE region transmits an uplink channel, the base station has difficulty in receiving it.

In order to solve this problem, a downlink channel or an uplink channel may be repeatedly transmitted over multiple subframes. Repeating the uplink/downlink channels on multiple subframes is referred to as bundle transmission.

Then, the IoT device or the base station can increase the decoding success rate by receiving a bundle of downlink/uplink channels on multiple subframes, and decoding a part or all of bundles.

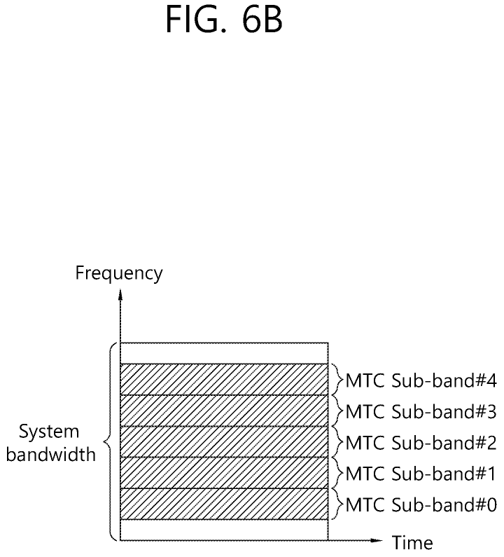

FIGS. 6A and 6B are diagrams illustrating examples of sub-bands in which IoT devices operate.

As one method for low-cost IoT devices, regardless of the system bandwidth of the cell as shown in FIG. 6A, the IoT device may use a sub-band of about 1.4 MHz for example.

In this case, an area of the subband in which the IoT device operates may be positioned in a central region (e.g., six middle PRBs) of the system bandwidth of the cell as shown in FIG. 6A.

Alternatively, as shown in FIG. 6B, a plurality of sub-bands of the IoT device may be used in one sub-frame for intra-subframe multiplexing between IoT devices to use different sub-bands between IoT devices. In this case, the majority of IoT devices may use sub-bands other than the central region of the system band of the cell (e.g., six middle PRBs).

The IoT communication operating on such a reduced bandwidth can be called NB (Narrow Band) IoT communication or NB CIoT communication.

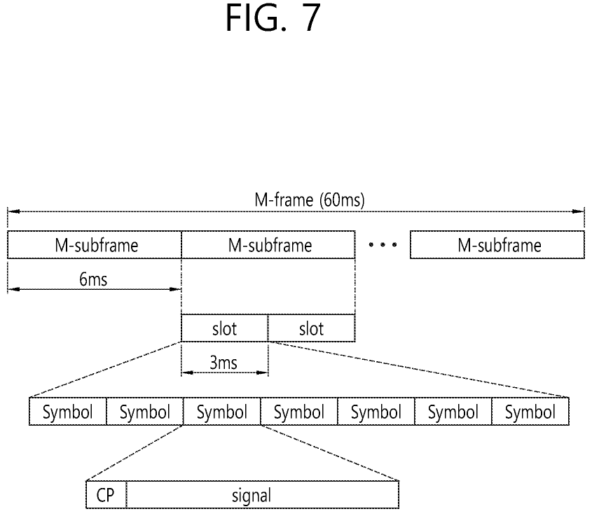

FIG. 7 illustrates an example of time resources that can be used for NB-IoT in M-frame units.

Referring to FIG. 7, a frame that may be used for the NB-IoT may be referred to as an M-frame, and the length may be illustratively 60 ms. Also, a subframe that may be used for the NB IoT may be referred to as an M-subframe, and the length may be illustratively 6 ms. Thus, an M-frame may include 10 M-subframes.

Each M-subframe may include two slots, and each slot may be illustratively 3 ms.

However, unlike what is shown in FIG. 6, a slot that may be used for the NB IoT may have a length of 2 ms, and thus the subframe has a length of 4 ms and the frame may have a length of 40 ms. This will be described in more detail with reference to FIG. 7.

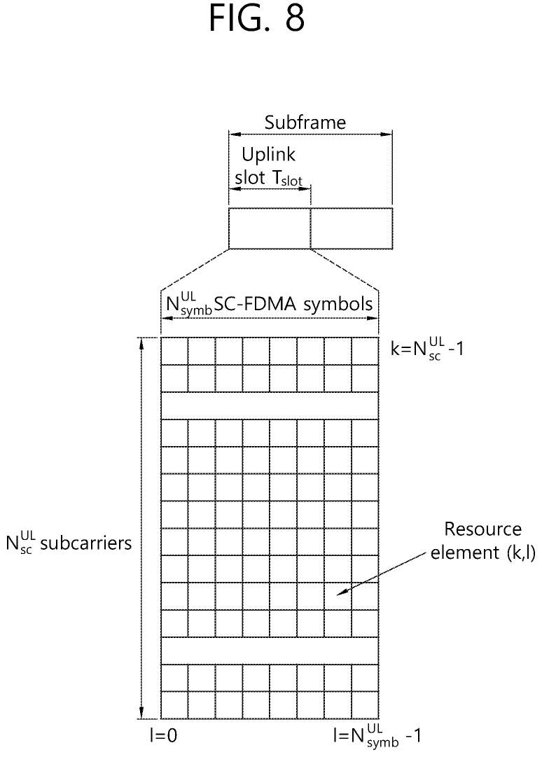

FIG. 8 is another illustration representing time resources and frequency resources that can be used for NB IoT.

Referring to FIG. 8, a physical channel or a physical signal transmitted on a slot in an uplink of the NB-IoT includes N_{symb}^{UL} SC-FDMA symbols in a time domain, and includes N_{SC}^{UL} subcarriers in a frequency domain. The physical channels of the uplink may be divided into a Narrowband Physical Uplink Shared Channel (NPUSCH) and a Narrowband Physical Random Access Channel (NPRACH). In the NB-IoT, the physical signal may be Narrowband DeModulation Reference Signal (NDMRS).

The uplink bandwidth of the N_{SC}^{UL} subcarriers during the Tₛₗₒₜ slot in the NB-IoT is as follows.

TABLE 1

| Subcarrier spacing | N_{SC}^{UL} | Tₛₗₒₜ |
|---|---|---|
| Δf = 3.75 kHz | 48 | 61440*Tₛ |
| Δf = 15 kHz | 12 | 15360*Tₛ |

In the NB-IoT, each resource element (RE) of the resource grid has k=0, N_{SC}^{UL}−1 indicating the time domain and frequency domain, when 1 is 1=0, N_{symb}^{UL}−1, it can be defined as an index pair (k, l) in a slot.

In the NB-IoT, downlink physical channels include an NPDSCH (Narrowband Physical Downlink Shared Channel), an NPBCH (Narrowband Physical Broadcast Channel), and a NPDCCH (Narrowband Physical Downlink Control Channel). The downlink physical signal includes a narrowband reference signal (NRS), a narrowband synchronization signal (NSS), and a narrowband positioning reference signal (NPRS). The NSS includes a Narrowband primary synchronization signal (NPSS) and a Narrowband secondary synchronization signal (NSSS).

Meanwhile, NB-IoT is a communication technology for wireless devices employing reduced bandwidth (namely narrow bandwidth) in consideration of low-complexity and low-cost operation. NB-IoT communication aims to support a large number of wireless devices to be connected to each other on the reduced bandwidth. Moreover, NB-IoT communication aims to support cell coverage broader than the cell coverage of the conventional LTE communication.

Meanwhile, as Table 1 shows, if the subcarrier spacing is 15 kHz, a subcarrier having the reduced bandwidth includes only one PRB. In other words, NB-IoT communication may be performed by using only one PRB.

On the other hand, since bandwidth for NB-IoT communication is small, a base station may not transmit a downlink control channel (namely, NPDCCH) and a downlink data channel (namely, NPDSCH) on the same subframe. In other words, when a base station transmits an NPDCCH on the subframe n, the base station may transmit an NPDSCH at the subframe n+k.

<The Next-Generation Mobile Communication Network>

Thanks to the success of the Long Term Evolution (LTE)/LTE-Advanced (LTE-A) for the 4-th mobile communication, the next-generation, namely, the fifth (so-called 5G) mobile communication is getting more attention, and more and more researches on that subject are being carried out.

The fifth-generation mobile communication as defined by the International Telecommunication Union (ITU) intends to provide a data transfer speed of up to 20 Gbps and an effective transfer speed of at least 100 Mbps or more at any location. The official name of the fifth-generation mobile communication is ‘IMT-2020’, of which global commercialization is targeted at 2020.

The ITU published three primary use scenarios based on the fifth-generation mobile communication, including enhanced Mobile BroadBand (eMBB), massive Machine Type Communication (mMTC), and Ultra Reliable and Low Latency Communication (URLLC).

URLLS pertains to a use scenario which requires high reliability and low latency. For example, services such as automated driving, factory automation, and augmented reality require high reliability and low latency (for example, latency less than 1 ms). The latency of the current 4G (LTE) communication ranges statistically from 21 to 43 ms (best 10%) and from 33 to 75 ms (median). This performance is not sufficient for supporting services based on latency less than 1 ms. Next, eMBB-based scenarios relate to use scenarios requiring mobile ultra-broadband.

In other words, the fifth-generation mobile communication system targets higher capacity than the current 4G LTE, increases density of mobile broadband users, and supports Device-to-Device (D2D), high reliability, and Machine Type Communication (MTC). Researches on the 5G system targets lower waiting time and lower battery consumption than the 4G mobile communication system to better implement the Internet of Things. To realize the aforementioned 5G mobile communication, a new radio access technology (New RAT or NR) may be proposed.

In the NR, a downlink subframe may be considered for reception from a base station while an uplink subframe may be considered for transmission to the base station. This way of operation may be applied to paired and unpaired spectra. One pair of spectra indicates that two subcarrier spectra are involved for downlink and uplink operations. For example, in one pair of spectra, one subcarrier may include a downlink and uplink bands forming a pair with each other.

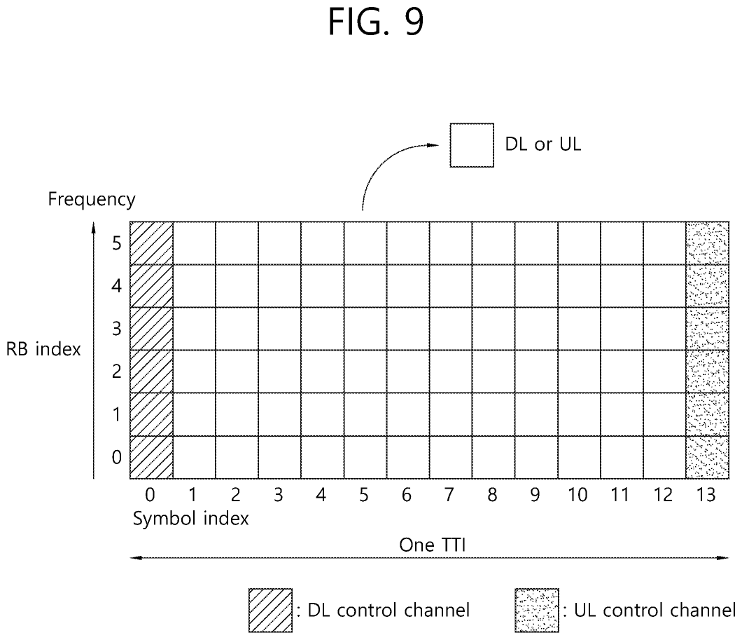

FIG. 9 illustrates an example of a subframe type in NR.

Transmission Time Interval (TTI) shown in FIG. 9 may be referred to as a subframe or slot for NR (or new RAT). The subframe (or slot) of FIG. 9 may be used in the TDD system of NR (or new RAT) to minimize data transfer latency. As shown in FIG. 3, a subframe (or slot) includes 14 symbols in the same way as a current subframe. The preceding symbols of a subframe (or symbol) may be used for a DL control channel, and the succeeding symbols of the subframe (or symbol) may be used for an UL control channel. Other symbols may be used for DL data transmission or UL data transmission. According to such a subframe (or slot) structure, downlink transmission and uplink transmission may be performed sequentially in one subframe (or slot). Therefore, downlink data may be received within a subframe (or slot), or an uplink acknowledgement response (ACK/NACK) may be transmitted within the subframe (or slot). Such a subframe (or slot) structure may be called a self-contained subframe (or slot). When such a subframe (or slot) structure is used, an advantage may be obtained that time taken for retransmitting erroneously received data is reduced, and thereby final data transmission waiting time is minimized. In the self-contained subframe (or slot) as described above, a time gap may be required to secure a transition process to and from a transmission and a reception mode. To this purpose, when the subframe structure transitions from DL to UL mode, part of OFDM symbols may be configured as Guard Periods (GPs).

Requirements on the 5G system include latency, peak data rate, and error correction. The 5G system expected to be used not only for mobile communication services but also for ultra-high resolution media streaming, Internet of Things, cloud computing, and self-driving vehicles targets much higher performance than the system requirements of the LTE system in many areas.

The 5G system targets 1 ms of latency, which is 1/10 of the LTE latency. This short latency is an important indicator in such a service area directly related to human life, like self-driving vehicles. The 5G system also targets a high transmission rate. The maximum transfer rate of the 5G system is targeted to be 20 times that of the LTE, and the effective transfer rate 10 to 100 times that of the LTE, by which high capacity ultra-high speed communication such as a high quality media streaming service may be sufficiently supported. Error-correction capability reduces data re-transmission rate and eventually improves latency and data transfer rate.

Turbo codes, polar codes, and LDPC codes are considered first as a 5G channel coding scheme.

First, turbo codes concatenate convolution codes in parallel, which apply different arrays of the same sequence to two or more component encoders. For a decoding method, turbo codes use a soft output iterative decoding method. Since the basic principle of turbo code decoding is to improve decoding performance by exchanging information about each bit within a decoding period and using the exchanged information for the next decoding, it is necessary to obtain soft output during a decoding process for turbo codes. This stochastic iterative decoding scheme leads to excellent performance and speed.

Next, an LDPC code relies on the characteristics of the LDPC iterative decoding scheme which improves error-correcting capability per bit by increasing the code length while retaining computational complexity per bit. Also, since codes may be designed so that computations for decoding may be performed in parallel, decoding of a long code may be processed at a high speed.

Lastly, a polar code has low encoding and decoding complexity and is the first error-correcting code which has been theoretically proven to achieve a channel capacity in a general binary input discrete memoryless symmetric channel. Differently from the LDPC and turbo code which use an iterative decoding process, the polar code uses Successive Cancellation (SC) decoding and list decoding in conjunction with each other. Also, differently from the LDPC code which improves performance by employing parallel processing, the polar code improves performance through pipelining.

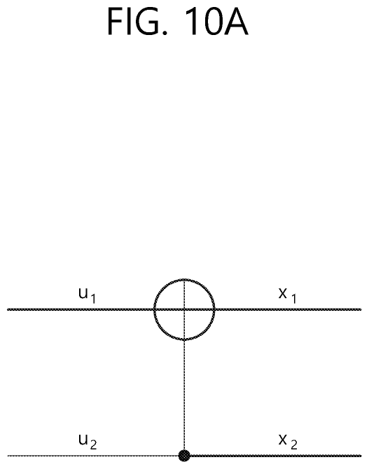

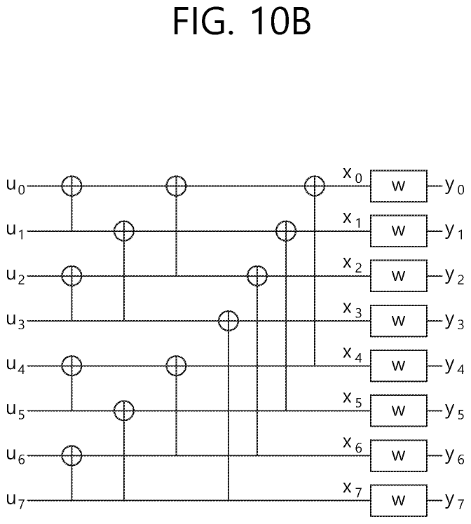

FIG. 10a illustrates a basic concept of a polar code, and FIG. 10b illustrates a structure of an SC decoder.

Referring to FIG. 10a, different inputs u1, u2 go through the respective channels and are output through x1, x2 separately. At this time, suppose u2 has gone through a relatively good channel, while u1 has gone through a channel in relatively poor conditions. If the structure of FIG. 10a is repeated, u2 which goes through channels in good conditions is getting better while u1 which goes through channels in poor conditions is getting worse, which may be structured as shown in FIG. 10b. This structure is called polarization.

The structure as shown in FIG. 10b may be expressed by a Kronecker product of two 2×2 kernel matrices. Therefore, an encoder is always built in the exponential form with a base of 2.

FIG. 10b assumes that the channel through which an input u7 passes is in better conditions than the channel through which an input u0 passes. In other words, it is assumed that a large index generally indicates a channel in good conditions.

The polar code exploits such a polarization effect, which maps data to a channel in good conditions and maps frozen bits (namely bit information known in advance, such as 0) to a channel in poor conditions.

At this time, a code rate is determined by the number of data bits divided by a sum of the number of data bits and the number of frozen bits.

<Disclosure of the Present Specification>

By its inherent characteristics, the block length of the polar code described above is limited by the size of a base kernel matrix. For example, when a polar code is designed based on a 2×2 kernel matrix, the block length always has a size of N=2ⁿ. Previous researches on the polar code have concentrated only on finding a method for creating a generator matrix of the polar code based on a single kernel matrix. However, in actual communication systems, size of a transmitted payload may vary. And the size of rate matching varies accordingly. In the previous researches, to overcome the difference between the block length of the polar code and the size of rate matching, rate matching techniques based on puncturing or repetition have been used. However, a first problem exists that rate matching based on puncturing or repetition reduces reliability of the polar code or is inherently incapable of guaranteeing optimized performance in terms of mother code rate.

On the other hand, an Aggregation Level (AL), which represents the number of CCEs used for transmission of a specific PDCCH by a base station, may be determined according to channel conditions. From the standpoint of a UE, it should be able to use the whole range of the AL used by the base station or select part of the ALs. Therefore, in order for a UE to take an AL to be used for decoding selectively from among the ALs transmitted by a base station, it is necessary that only a few ALs are used for successful decoding. However, up to now, it has been reported that no methods were effective to allow decoding to be performed successfully with only a few ALs.

Therefore, the first disclosure of the present specification aims to propose a method for solving the first problem. And the second disclosure of the present specification aims to proposes a method for solving a second problem.

I. First Disclosure

The first disclosure takes into account the situation where the polar code is used as a channel coding scheme of NR.

The first disclosure of the present specification proposes a method for building a generator matrix by using a combination of one or more kernel matrices to overcome the first problem. In particular, the proposed method deals with a method for improving granularity by varying the types of block lengths that may be expressed by the polar code. The first disclosure considers all of kernel matrices that may be generated with a size of l×l for an arbitrary integer l larger than or equal to 2.

For the convenience of descriptions, the first disclosure uses the following definitions.
N: Block length of the polar code
M: Rate matching bit size
r: Size of a base kernel matrix
n(r): Exponent of r

The block length of the proposed polar code may be calculated by the following equation.

$$N = {\prod }_{r > 1} {r}^{n ( r )} . \qquad [ Eq . 3 ]$$

Here, r represents the size of a base kernel matrix and has an integer value larger than 1, which may in general use a prime number. n(r) indicates how many times the Kronecker product is performed on a kernel matrix of size r. As one example, if the numbers 2, 3, and are used as the base kernel matrix, and n(2)=a, n(3)=b, and n(5)=c, the size of the block length becomes N=2^{a}·3^{b}·5^{c}.

The values of n(r) for each r may be determined by the size of N. For example, when r that may be used is fixed to a prime number, a method for expressing a specific size N by using r and n(r) is uniquely determined. Similarly, the values of n(r) may be determined by the size of M. This case may be applicable when the size of N to be used is determined with respect to the size of M. For example, if the size of N is determined to have a value larger than M, and available values for r is 2, 3, and 5, values of n(r) for each r may be determined from the condition of min{N=2ⁿ⁽²⁾·3ⁿ⁽³⁾·5ⁿ⁽⁵⁾, N>M}. As another example, if the size of N is determined to have a value smaller than M, and available values for r is 2, 3, and 5, the value of N and values of n(r) for each r may be determined from the condition of min{N=2ⁿ⁽²⁾·3ⁿ⁽³⁾·5ⁿ⁽⁵⁾, N<M}. The size of N may be determined by various criteria in addition to the specific examples. The size of N may be determined so that a size to be generated is selected by a combination of an available value of r and values of n(r) for each r.

The available value of r and the maximum value of n(r) for each r may be limited by an employed system. This may be intended to reduce complexity that may be caused when the types of available kernel matrices are increased. For example, the available value of r may be limited to 2 and 3, and the maximum value of n(r) may be determined to satisfy n(2)≤aₘₐₓ, n(3)≤bₘₐₓ. Such a limitation may differ according to the service employed. For example, a criterion based on which a limitation is applied for an eMBB use scenario may be different from that for an URLLC or mMTC use scenario.

Similarly, a limitation applied may vary depending on the capability/performance or category of a UE. In this case, the value of r available for a UE with higher capability/performance and the maximum value of n(r) for each r may be determined so as to include the whole or part of the value of r available for a UE with lower capability/performance and the maximum value of n(r) for each r. This may be intended to support a design of a common channel that needs to be monitored by all of the UEs, such as a Common Search Space (CSS). As one example, it may be determined that a UE with lower capability/performance supports 2 for the value of r and n(2)≤aₘₐₓ. And for a UE with higher capability/performance, it may be determined to support 2 and 3 for the value of r and n(2)≤aₘₐₓ and n(3)≤bₘₐₓ. As described above, if an available value for r and n(r) are different according to the capability/performance or category of an UE, the UE may report its capability/performance or category to the base station. Such reporting may be performed through a first message (namely, random access preamble) or a third message (namely, a scheduled message) while the UE performs a random access process. This may be intended to have various block lengths that may be used in a channel for receiving USS, CSS, or data. Or, depending on the capability of a base station, the value of r that may be supported and the maximum value of n(r) for each r may vary. In this case, a base station may inform of the information about the value of r that may be supported by the base station and the maximum value of n(r) for each r through a System Information Block (SIB) or Radio Resource Control (RRC) signaling.

The generator matrix of the polar code built by using a criterion for selecting the r and n(r) described above may be expressed in the form of a Kronecker product of kernel matrices. At this time, the order of performing the Kronecker product may be determined according to the form of a generator matrix to be used. For example, a 2×2 base kernel matrix G₂ and a 3×3 base kernel matrix G₃ may be defined as follows.

$${G}_{2} = [ \begin{matrix}1 & 0 \\ 1 & 1\end{matrix} ] , {G}_{3} = [ \begin{matrix}1 & 0 & 0 \\ 0 & 1 & 0 \\ 1 & 0 & 1\end{matrix} ] \qquad [ Eq . 4 ]$$

A generator matrix of the polar code built from the equation above may be expressed as follows.

G=G₃^{⊗n(3)}⊗G₂^{⊗n(2)} [Eq. 5]

At this time, ⊗ denotes the Kronecker product, and the Kronecker power is denoted if ⊗ is applied to the position of exponent. For example, a generator matrix of the polar code when n(2)=2 and n(3)=1 may have the following form.

$$[ \begin{matrix}1 & 0 & 0 & 0 & 0 & 0 & 0 & 0 & 0 & 0 & 0 & 0 \\ 1 & 1 & 0 & 0 & 0 & 0 & 0 & 0 & 0 & 0 & 0 & 0 \\ 1 & 0 & 1 & 0 & 0 & 0 & 0 & 0 & 0 & 0 & 0 & 0 \\ 1 & 1 & 1 & 1 & 0 & 0 & 0 & 0 & 0 & 0 & 0 & 0 \\ 0 & 0 & 0 & 0 & 1 & 0 & 0 & 0 & 0 & 0 & 0 & 0 \\ 0 & 0 & 0 & 0 & 1 & 1 & 0 & 0 & 0 & 0 & 0 & 0 \\ 0 & 0 & 0 & 0 & 1 & 0 & 1 & 0 & 0 & 0 & 0 & 0 \\ 0 & 0 & 0 & 0 & 1 & 1 & 1 & 1 & 0 & 0 & 0 & 0 \\ 1 & 0 & 0 & 0 & 0 & 0 & 0 & 0 & 1 & 0 & 0 & 0 \\ 1 & 1 & 0 & 0 & 0 & 0 & 0 & 0 & 1 & 1 & 0 & 0 \\ 1 & 0 & 1 & 0 & 0 & 0 & 0 & 0 & 1 & 0 & 1 & 0 \\ 1 & 1 & 1 & 1 & 0 & 0 & 0 & 0 & 1 & 1 & 1 & 1\end{matrix} ] \qquad [ Eq . 6 ]$$

The base kernel matrix used in the example above and the form of a generator matrix generated from the base kernel matrix are an example introduced for the convenience of descriptions, and a method for constructing a generator matrix according to the present invention may be applied generally to the form of a generator matrix composed by a different combination of a base kernel matrix in a different form.

When a generator matrix is constructed by using one or more r values, it is possible to design base kernel matrices having the same r value to be arranged in a consecutive order by taking into account encoding/decoding complexity. For example, when a generator matrix is designed by using a base kernel matrix having the size of r1 and a base kernel matrix having the size of r2, the generator matrix may be constructed by generating a kernel matrix Gᵣ₁^{⊗n(r1)} composed by using r1 and a kernel matrix Gᵣ₂^{⊗n(r2)} composed by using r2 respectively and then performing the Kronecker product of the two kernel matrices.

As another method for constructing a kernel matrix in addition to 2×2 kernel matrices, a method for applying an extended form of the 2×2 kernel matrix may be considered. Such a kernel matrix may be constructed by applying a puncturing block and a frozen bit block to the kernel matrix applied in the final step. For example, the following methods may be used to construct a 3×3 kernel matrix by using a 4×4 kernel matrix or an 8×8 kernel matrix generated from the Kronecker product of two 2×2 kernel matrices.

| Original kernel matrix | Puncturing block/frozen bit block | 3 × 3 kernel matrix |
|---|---|---|
| $[ \begin{matrix}1 & 0 & 0 & 0 \\ 1 & 1 & 0 & 0 \\ 1 & 0 & 1 & 0 \\ 1 & 1 & 1 & 1\end{matrix} ]$ | Puncturing block: 4th column/ frozen bit block: 4th row | $[ \begin{matrix}1 & 0 & 0 \\ 1 & 1 & 0 \\ 1 & 0 & 1\end{matrix} ]$ |
| | Puncturing block: 4th column/ frozen bit block: 3rd row Puncturing block: 2nd column/ frozen bit block: 2nd row | $[ \begin{matrix}1 & 0 & 0 \\ 1 & 1 & 0 \\ 1 & 1 & 1\end{matrix} ]$ |
| | Puncturing block: 1st column/ frozen bit block: 1st row | $[ \begin{matrix}1 & 0 & 0 \\ 0 & 1 & 0 \\ 1 & 1 & 1\end{matrix} ]$ |
| $[ \begin{matrix}1 & 0 & 0 & 0 & 0 & 0 & 0 & 0 \\ 1 & 1 & 0 & 0 & 0 & 0 & 0 & 0 \\ 1 & 0 & 1 & 0 & 0 & 0 & 0 & 0 \\ 1 & 1 & 1 & 1 & 0 & 0 & 0 & 0 \\ 1 & 0 & 0 & 0 & 1 & 0 & 0 & 0 \\ 1 & 1 & 0 & 0 & 1 & 1 & 0 & 0 \\ 1 & 0 & 1 & 0 & 1 & 0 & 1 & 0 \\ 1 & 1 & 1 & 1 & 1 & 1 & 1 & 1\end{matrix} ]$ | Puncturing block: 1st, 3rd, 4th, 6th, and 8th columns/ frozen bit block: 1st, 3rd 4th, 5th, and 8th rows | $[ \begin{matrix}1 & 0 & 0 \\ 1 & 1 & 0 \\ 0 & 1 & 1\end{matrix} ]$ |

At this time, the definition of a puncturing block is an area corresponding to a column index of the final kernel matrix, indicating the portion not used in the output bits. Also, the definition of a frozen bit block is an area corresponding to a row index of the final kernel matrix, indicating the portion not used as information in terms of input bits.

Meanwhile, the first disclosure proposes a method for designing a generator matrix of the polar code so that even when a base kernel matrix for two or more r values is used to construct a generator matrix of the polar code, decoding may still be performed at the receiver (for example, UE) with a base kernel matrix for one r value. Such a method for designing a generator matrix may be intended to enable a decoder of the receiver (for example, UE) to perform decoding according to its capability even if the type of available r and capability for the maximum value of n(r) for each r are different between the encoder of a transmitter (for example, a base station) and the decoder of the receiver (for example, UE). For example, suppose a structure is given, where 2 and 3 are used for the value of r, and n(2)=a, and n(3)=1. In this case, a 2×2 base kernel matrix G2 and a 3×3 base kernel matrix G3 may use the following structures.

$${G}_{2} = [ \begin{matrix}1 & 0 \\ 1 & 1\end{matrix} ] , {G}_{3} = [ \begin{matrix}1 & 0 & 0 \\ 0 & 1 & 0 \\ 1 & 1 & 1\end{matrix} ] \qquad [ Eq . 7 ]$$

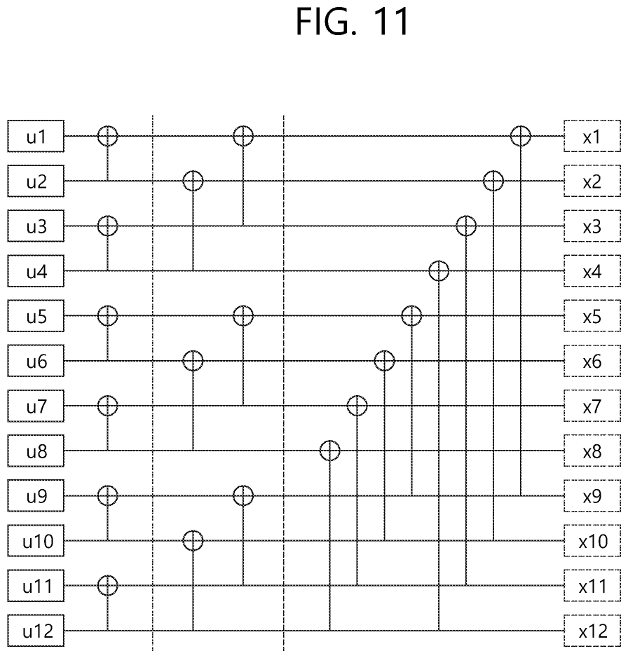

When a generator matrix in the form of G=G₃^{⊗1}⊗G₂^{⊗a} is constructed by using the based kernel matrices defined, the decoder of the receiver (for example, UE) may perform decoding by using the constructed generator matrix or by using only G₂. For example, when n(2)=2, and n(3)=1, the structure of an encoder of the polar code, which has a block length of 12, may be implemented as shown in FIG. 11.

FIG. 11 illustrates an encoder structure of a polar code according to the first disclosure of the present specification.

A decoder capable of using the generator matrix G shown in FIG. 11 may perform decoding of u1-u12 by using the generator matrix G based on the received signal x1-x12. On the other hand, if decoding has to be performed by using only G₂ at the occurrence of a specific constraint, the decoder may perform decoding of u1-u4 and u9-u12 by using x1-x4 and x9-x12 based on G₂^{⊗a+1} and decoding of u5-u8 and u9-u12 by using x5-x8 and x9-x12 based on G₂^{⊗a+1}, respectively. Similarly, to reduce decoding complexity, the decoder of the receiver (for example, UE) may perform decoding of u1-u4 and u9-u12 by using x1-x4 and x9-x12 based on G₂^{⊗a+1} and decoding of u5-u8 by using x5-x8 and u9-u12 based on G₂^{⊗a}, respectively.

When an actual signal is transmitted by using the method for constructing a generator matrix of the polar code described above, a transmission block may be constructed by using a combination of one or more time/frequency resource transmission blocks. The aforementioned time/frequency resource transmission block may include a combination of a transmission unit of a resource defined on the frequency axis such as a PRB and a transmission unit of a resource defined on the time axis such as a symbol, slot, or subframe. For example, the aforementioned generator matrix of the polar code may be used for mapping information to one or more CCEs and determining a decoding structure. The receiver (for example, UE) may determine the structure of a required generator matrix according to the number of CCEs by using the methods described above.

II. Second Disclosure

The second disclosure proposes an encoding/decoding structure of the polar code capable of supporting multiple aggregation levels when the polar code is employed as a coding scheme for a control channel of NR.

By its inherent characteristics, the polar code provides an advantage that the mother code rate may be determined according to the encoder input bit size and information bit size of the polar code. In other words, while a channel coding scheme of convolutional code family is able to extend the encoding rate only through a rate matching technique such as repetition and puncturing from a set mother code rate, a channel coding scheme based on the polar code provides an advantage that the mother code rate may vary depending on situations. However, differently from general linear channel coding schemes such as the Low-Density Parity-Check (LDPC) or Reed-Muller (RM) code, since the channel coding scheme based on the polar code increases the size of input bits for encoding in the exponential form with a base of the size of a base kernel matrix, a disadvantage is caused that a process for determining the mother code rate is limited.

The second discloser proposes a method for designing a transmission signal by taking into account the characteristics of the polar code so that in a situation where a base station transmits a PDCCH at a specific AL, a UE may monitor the PDCCH through various ALs. Also, to optimize decoding performance at each AL, the second disclosure proposes a method for arranging encoding input bits and a method for selecting encoder output bits. In what follows, although the second disclosure is described with respect to a PDCCH for the purpose of convenience, it should be understood clearly that the content to be described below may be generally extended to various transmission channels to which the concept of AL is applied.

Also, the second disclosure proposes a method for selecting an optimal location of a frozen bit/unfrozen bit of encoding based on the polar code for all of the ALs which may be selected within the ALs used for transmission of the PDCCH by a base station. At this time, the location of the optimized frozen bit/unfrozen bit may be the location at which channel reliability may be improved with respect to input bits of an encoder. For example, a method for determining the location of a frozen bit/unfrozen bit through calculation of channel reliability employing density evolution may be used. At this time, the location of a bit with high reliability may vary according to the input bit size of the encoder. On the other hand, a rule which selects the location of an encoder input bit according to a specific criterion may exist, and the frozen bit/unfrozen bit location may be determined according to the input bit size of the encoder determined by the rule. For example, the location of a frozen bit/unfrozen bit may be determined by the number of 1s found in a row vector corresponding to the index of input bit of each encoder in a generator matrix of the polar code. At this time, the index of an input bit of each encoder may be rearranged in the order of the number of 1s, and the location of an unfrozen bit may be selected sequentially from the index having the largest number of is among the rearranged indexes. Similarly, a weight may be calculated by applying each index of an input bit of the encoder to a specific equation, indexes may be rearranged with respect to the size of the weight, and the location of an unfrozen bit may be selected in the order of the size of the weight. It is apparent that the content of the second disclosure may be applied even if a different selection method is used in addition to the method for selecting a frozen/unfrozen bit descried above.

In what follows, for the convenience of descriptions, it is assumed that the aggregation level of a PDCCH transmitted by a base station is L, each CCE uses a polar code encoded with a size of N(=2ⁿ), and the size of information to be transmitted is K (<N). The encoder of a transmitter (for example, a base station) first determines the location of the optimized frozen bit/unfrozen bit among N bit sizes of the encoder with respect to AL=1. Then the encoder of the transmitter (for example, base station) disposes the K information bits at the unfrozen bit locations. A set of locations of unfrozen bits optimized with respect to N bit size is defined as set_(1) for the sake of convenience. Therefore, when channel conditions are good, the receiver (for example, UE) may decode information by using only the CCEs for AL=1. Here, the CCEs generated through the encoding process for AL=1 is defined as CCE_{AL(1)}. The polar code for AL=2 may be generated by adding output bits of size N of the encoder to the output bits of size N of the encoder generated for AL=1. Here, the input bits of the encoder for AL=2 may be generated by adding input bits of size N of the encoder to a set of input bits of size N of the encoder for AL=1. In this case, a total size of the input bits of the encoder becomes 2*N, and optimized locations of frozen bits/unfrozen bits corresponding to 2*N may be newly determined. At this time, a set of locations of K unfrozen bits optimized with respect to 2*N size is defined as set_(2) for the sake of convenience. K information bits are disposed at the locations of the K unfrozen bits. At this time, since channel conditions may vary as much as the increased dimension of input bits of the encoder, part of bit locations included in the set_(1) may not be included in set_(2), and the bit locations are defined as old_set_(2-1). Also, among input bits of N size added to the encoder, a location set of the bits included in the set_(2) is defined as new_set_(2). Meanwhile, for the input bits of size N added to the encoder, information bits disposed in the old_set(2-1) may be inserted to the bit locations defined in the new_set_(2). The additional CCEs generated through the aforementioned encoding process is defined as CCE_{AL(2)}. CCE_{AL(2)} reflects the effect of both the input bits of set_(1) and input bits of new_set(2). Therefore, when AL=2, the base station may transmit a signal of AL=2 composed of CCE_{AL(1)} and CCE_{AL(2)}. The operation may be performed in the same manner until the AL that the base station wants to transmit becomes L. For example, when AL=3 and AL=4, a location set of frozen bits/unfrozen bits optimized with respect to the input bits of size 4*N of the encoder, set_(3), may be applied. AL=3 and AL=4 have to be dealt with simultaneously because considering the characteristics of the polar code based on a 2×2 kernel matrix, the input bit size of the encoder has to be expressed in the exponential form with a base of 2. The effect by the exponential form with a base of 2 has to be considered in the same way for an arbitrarily larger size L. A set of information bits inserted to the locations of additional input bits of the encoder for AL=3 and AL=4 may be applied in the same way as a method for selecting input bits of the encoder for AL=2. A method for generating CCE_{AL(3)} corresponding to AL=3 and CCE_{AL(4)} corresponding to AL=4 may be applied in the same way for a method for performing puncturing. Generation of CCE_{AL(3)} may be performed by using a method for selecting optimal N bits from among output bits added to the encoder to support AL=3 and AL=4. At this time, the method for selecting optimized N bits may be performed according to the priorities of a selection criterion for improving decoding reliability and a heuristic criterion which determines a puncturing pattern. Generation of CCE_{AL(4)} may be determined to select the remaining N bits except for the bits selected as CCE_{AL(3)} from among output bits added to the encoder to support AL=3 and AL=4. A method for composing CCEs may be determined in an ascending order from a low AL to a high AL by applying the same criterion even to an arbitrary AL which has a larger size.

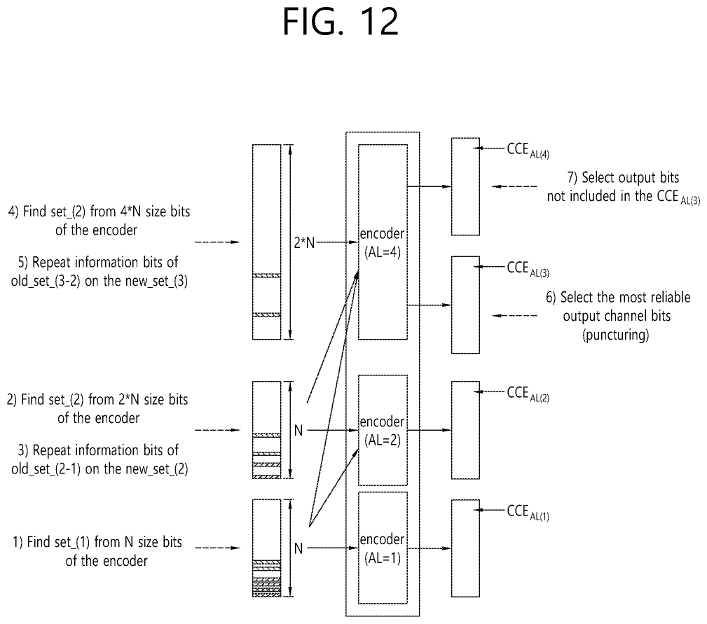

FIG. 12 illustrates a method for generating a CCE of a PDCCH when AL=4.

The structure of the encoder shown in FIG. 12 is represented in a separate form for the sake of convenience. However, the structure provides the same effect as when one 4*N sized encoder is used, which applies in the same way for an arbitrary value of L.

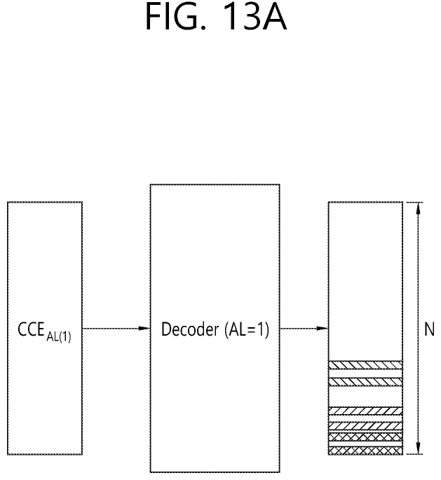

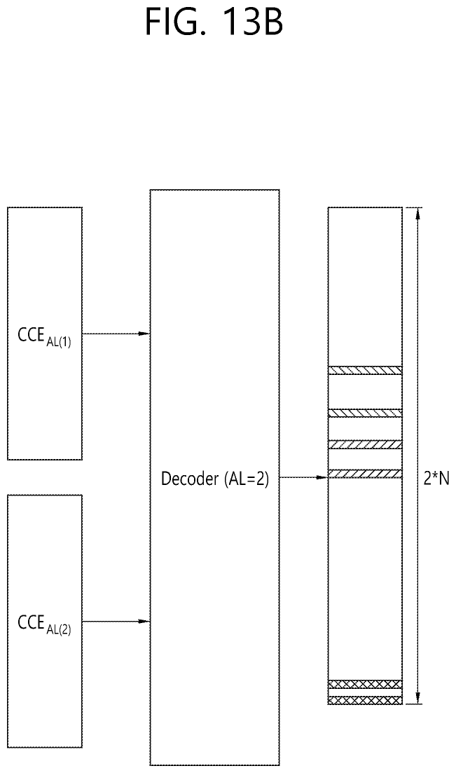

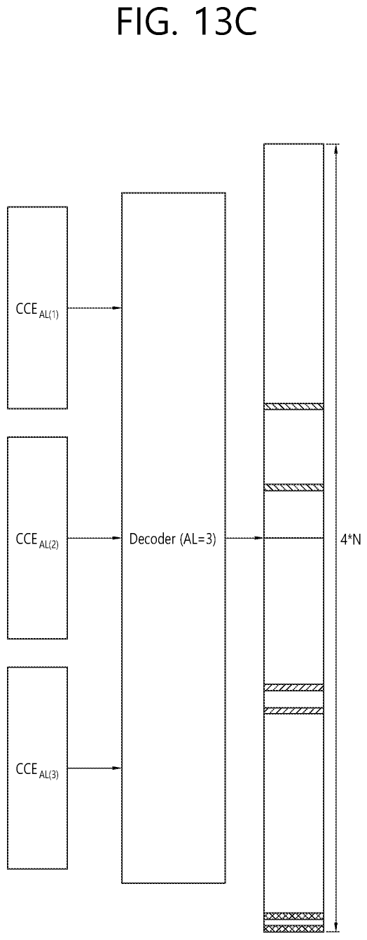

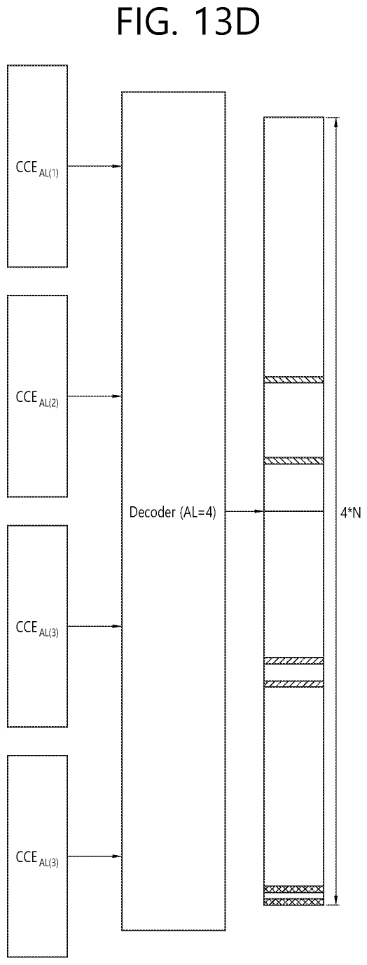

FIGS. 13a to 13d illustrate a decoding process which varies according to the number of CCEs used by a decoder of a receiver is changed.

As shown in FIGS. 13a to 13d, according to the number of CCEs used for decoding from the viewpoint of a receiver (for example, UE), locations of data bits assumed by the receiver (for example, UE), locations of frozen bits, and interpretation of the content may be changed. As shown in FIG. 13a, when one CCE is used, a polar code-based decoder of size N may be used. As shown in FIG. 13b, when two CCEs are used, a polar code-based decoder of size 2*N may be used. As shown in FIGS. 13c and 13d, when 3 or 4 CCEs are used, a polar code-based decoder of size 4*N may be used. When the receiver (for example, UE) performs decoding by using two or more CCEs, the values of some repeated bits may be used for decoding the values of the bits whose decoding turn comes late based on the information of the bits decoded first according to a sequential decoding order. For example, if bit locations are changed between the case where specific information uses one CCE and the case where the specific information uses two or more CCEs, those bits before bit locations are changed may be treated as frozen bits according to a decoding result based on the changed bit locations. In another example, suppose bit locations are changed between the case where specific information uses one CCE and the case where the specific information uses two or more CCEs. If two values from decoding of the corresponding two bits are the same, the decoding result may be accepted but discarded, otherwise. At this time, if the receiver (for example, UE) is capable of performing list decoding, both values of the corresponding bit for the two cases in a first decoding pass may be retained as a decoding path, and one decoding path may be discarded later by using a decoding result at repeated locations.

Meanwhile, although the descriptions give above assume that the number of CCEs is increased along the frequency axis according to AL, the number of CCEs may be increased along the time axis according to AL in another one embodiment. Similarly, if AL=2, and two CCEs are transmitted by using difference resources of the time axis, the receiver (for example, UE) may perform decoding sequentially according to each AL. For example, as shown in FIG. 13a, after receiving one CCE, the receiver (for example, UE) may perform decoding of the polar code with size N. If a decoding result may not be reliable (for example, when the decoding results fails to pass a CRC check), the receiver (for example, UE) may decode a CCE on the next time resource. The decoding may be performed by using previous decoding results in a cumulative manner. If the receiver (for example, UE) succeeds in decoding at a specific AL, the receiver (for example, UE) may not perform decoding for additional CCEs.

On the other hand, to generate a signal based on the proposed AL structure, an encoder of a transmitter (for example, base station) may determine the locations of encoding input bits in a descending order. For example, when the maximum AL is 4, the encoder may first determine the optimized frozen/unfrozen bit location among 4*N sized input bit locations of the encoder with respect to AL=4 and dispose K pieces of information. At this time, locations of the optimized unfrozen bits are defined as set_(3*) for the sake of convenience. Suppose the structure when AL=4 is to be distinguished from the structure when AL=2. A total number of decodable input bits of the encoder when AL=2 may be 2*N. At this time, the 2*N determined bits may not include part of information bits used for the case where AL=4, which is defined for the sake of convenience as set_(3-2*). Therefore, in order to receive all of the information bits when AL=2, the bits included in the set_(3-2*) may be added to be included in the decodable input bits of the encoder when AL=2. At this time, locations of the bits to be added may be determined according to the order of bit locations optimized based on the polar code of 2*N size, but the bit locations selected when AL=4 may be blocked from being selected for the locations of additional bits. The locations of the newly added bits are defined as new_set_(2*) for the sake of convenience. In the same way, when the structure for AL=2 is to be distinguished from the structure for AL=1, a total number of decodable input bits of the encoder when AL=1 may be N. At this time, the N determined bits may not include part of information bits used for the case where AL=2, which is defined for the sake of convenience as set_(2-1*). Therefore, in order to receive all of the information bits when AL=1, the bits included in the set_(2-1*) may be added to be included in the decodable input bits of the encoder when AL=1. At this time, locations of the bits to be added may be determined according to the order of bit locations optimized based on the polar code of size N, but the bit locations selected when AL=4 and Al=2 may be blocked from being selected for the locations of additional bits. The locations of the newly added bits are defined as new_set_(1*) for the sake of convenience. By applying the information of set_(3*), new_set_(2*), and new_set_(1*) generated through the aforementioned sequential bit location selection methods and information bits corresponding to the respective locations together, a total of 4*N encoder input bits may be formed and encoded through a generator matrix with a size of (4*N)×(4*N). The encoder output bits of 4*N size generated through the operation above may comprise a total of 4 CCEs. Although the present invention is described with respect to the case where AL=4 for the sake of convenience, it should be understood that the present invention may also be applied to an arbitrary value of L.

Meanwhile, the present invention proposes that when AL is larger than a specific threshold (for example, an arbitrary natural number J), additional information bit positions are no longer generated, but previously generated CCEs are repeated. For example, J CCEs may be generated by using a method for determining optimized bit positions according to each AL until AL reaches J; and when AL is larger than J (AL>J), previously generated CCEs may be repeated. This is so intended that beyond a specific AL size, optimized bit locations may not reveal a change or noticeable difference and may not exert a significant effect on the performance. Or, it may be intended to prevent complexity of an encoder or decoder from being increased due to the increase of input/output bits to be encoded or decoded. The threshold value J based on which repetitions are applied may be configured by higher layer signaling (for example, RRC signaling). Similarly, the threshold J may be defined by a function based on parameters related to channel coding, such as the size of information bits, size of bits constituting each CCE. For example, a period may be divided based on an encoding rate, and a J value may be defined according to each divided period. Also, the J value may be defined according to the format of a control channel used for each SS. In this case, the receiver may recognize the structure composed of CCEs according to the AL based on the format that the receiver wants to detect.

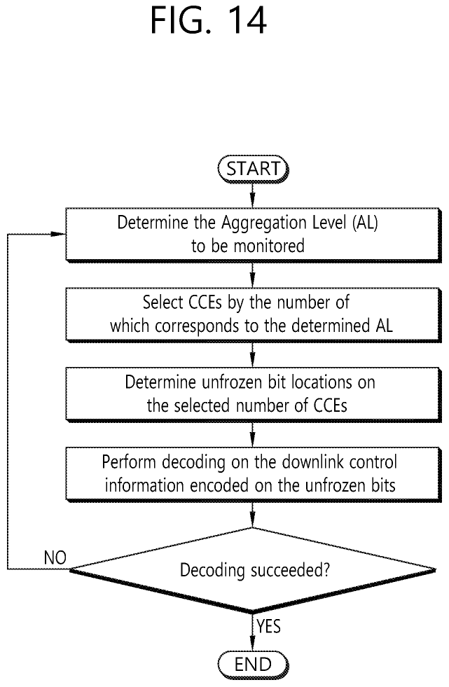

On the other hand, the receiver (for example, UE) may determine the AL to be monitored by considering channel conditions of the receiver and may select and decode CCEs, the number of which corresponds to the determined aggregation level. More specifically, this operation will be described with reference to FIG. 14.

FIG. 14 is a flow diagram illustrating a decoding method of a receiver according to the second disclosure.

A receiver (for example, UE) determines an Aggregation Level (AL) to be monitored by considering channel conditions of the receiver. For example, the receiver (for example, UE) may determine the lowest AL suitable for the channel conditions of the receiver.

And the receiver (for example, UE) selects CCEs, the number of which corresponds to the determined AL. For example, if it is determined that channel conditions are good, it is determined that AL=1, and the minimum number, namely one CCE may be selected accordingly.

Next, the receiver (for example, UE) determines the frozen bit location and unfrozen bit location of the polar code on the selected minimum number of CCEs. For example, if it is determined that AL=1, the receiver (for example, UE) may determine the location of set_(1) on the CCE_{AL(1)} as the unfrozen bit.

Next, the receiver (for example, UE) performs first decoding of the polar code with respect to the downlink control information encoded on the unfrozen bit.

If the first decoding fails, the receiver (for example, UE) determines a higher AL. For example, Al may be set to 2.

And the receiver (for example, UE) selects CCEs, the number of which corresponds to the determined AL. For example, if AL=2, two CCEs may be selected.

And the receiver (for example, UE) determines frozen bit locations and unfrozen bit locations of the polar code on the selected number of CCEs. And the receiver (for example, UE) performs second decoding on the downlink control information encoded on the determined unfrozen bit locations. For example, when AL=2, the receiver (for example, UE) performs decoding of the polar code of 2*N size on the CCE_{AL(1)} and CCE_{AL(2)}. The locations of the unfrozen bits may be determined based on set_(2). At this time, one of the following three methods may be performed on the bits corresponding to old_set(2-1).

(Option 3-1) Processes the bits corresponding to old_set(2-1) as frozen bits by using a result of decoding performed for new_set_(2).

(Option 3-2) Performs a parity check on the locations of old_set_(2-1) by using a result of decoding performed for new_set_(2)

(Option 3-3) Combines new_set_(2) and old_set_(2-1) according to the Log-Likelihood Ratio (LLR) scheme and decode the combination

Option 3-1 may be intended to utilize the effect of a more reliable channel without increasing complexity of a decoder. Option 3-2 may be intended to reduce the number of paths of a decoder which uses list decoding. And option 3-3 may be intended to obtain an effect of repetition gain in a decoder which uses list decoding.

The embodiments of the present invention may be implemented by various means. For example, embodiments of the present invention may be implemented by hardware, firmware, software, or a combination thereof. Implementation of the present invention will be described with reference to a related drawing in more detail.

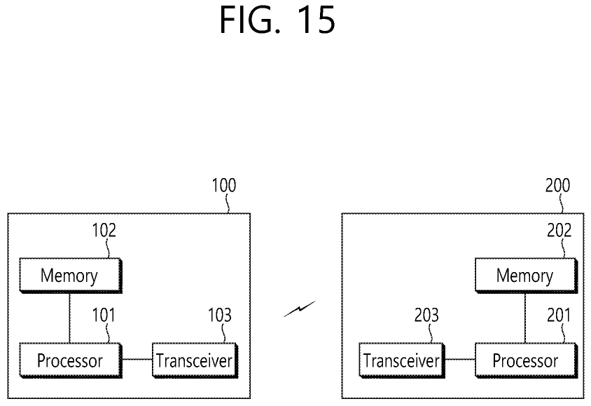

FIG. 15 illustrates a block diagram of a wireless communication system in which a disclosure of the present specification is implemented.

The base station 200 comprises a processor 201, memory 202, and transceiver (or Radio Frequency (RF) unit) 203. The memory 202, being connected to the processor 201, may store various pieces of information for operating the processor 201. The transceiver (or RF unit) 203, being connected to the processor 201, transmits and/or receives a radio signal. The processor 201 implements proposed functions, processes, and/or methods. In the embodiments above, operation of the base station may be implemented by the processor 201.

The wireless device (for example, an NB-IoT device) 100 comprises a processor 101, memory 102, and transceiver (or RF unit) 103. The memory 102, being connected to the processor 101, may store various pieces of information for operating the processor 101. The transceiver (or RF unit) 103, being connected to the processor 101, transmits and/or receives a radio signal. The processor 101 implements proposed functions, processes, and/or methods.

The processor may include Application-Specific Integrated Circuit (ASIC), other chipset, logical circuit and/or data processing device. The memory may include Read-Only Memory (ROM), Random Access Memory (RAM), flash memory, memory card, storage medium and/or other storage device. The RF unit may include a baseband circuit for processing a radio signal. When an embodiment is implemented by software, the aforementioned method may be implemented by a module (process or function) which performs the aforementioned function. A module may be stored in the memory and executed by the processor. The memory may be installed inside or outside the processor and may be connected to the processor via various well-known means.

In the exemplary system described above, methods are described according to a flow diagram by using a series of steps and blocks. However, the present invention is not limited to a specific order of the steps, and some steps may be performed with different steps and in a different order from those described above or simultaneously. Also, it should be understood by those skilled in the art that the steps shown in the flow diagram are not exclusive, other steps may be further included, or one or more steps of the flow diagram may be deleted without influencing the technical scope of the present invention.

What is claimed is:

1. A method for decoding downlink control information, the method comprising:
selecting a minimum number of Control Channel Elements (CCEs) suitable for a current channel situation in an Aggregation Level (AL) defining the number of CCEs of a control channel in which downlink control information is encoded;
determining a frozen bit location and an unfrozen bit location of a polar code in the selected minimum number of CCEs; and
performing first decoding of the polar code for the downlink control information encoded in the unfrozen bits.

2. The method of claim 1, further comprising:
selecting a larger number of CCEs than the minimum number if the first decoding fails;
determining a frozen bit location and an unfrozen bit location of a polar code on the selected number of CCEs; and
performing second decoding of a polar code on the downlink control information encoded on the determined unfrozen bit location.

3. The method of claim 2, wherein, if the selected minimum number is 1, the frozen bit location and the unfrozen bit location of the polar code on the one CCE are determined, and if the decoding fails and two CCEs, which is larger than the minimum number, 1, are selected, the frozen bit locations and the unfrozen bit locations of the polar code on the two CCEs are determined.

4. The method of claim 3, wherein a set of unfrozen bit locations on the two CCEs do not include a set of unfrozen bit locations on the one CCE.

5. The method of claim 2, further comprising
performing a parity check on a result of performing the first decoding by using a result of performing the second decoding.

6. The method of claim 2, further comprising
combining a result of performing the first decoding and a result of performing the second decoding according to a Log-Likelihood Ratio (LLR) scheme.

7. A UE for decoding downlink control information, the UE comprising:
a transceiver; and
a processor controlling the transceiver, wherein the processor is configured to
select a minimum number of Control Channel Elements (CCEs) suitable for a current channel situation in an Aggregation Level (AL) defining the number of CCEs of a control channel in which downlink control information is encoded;
determine a frozen bit location and an unfrozen bit location of a polar code in the selected minimum number of CCEs; and
perform first decoding of the polar code for the downlink control information encoded in the unfrozen bits.

8. The UE of claim 1, wherein the processor is further configured to:
select a larger number of CCEs than the minimum number if the first decoding fails;
determine a frozen bit location and an unfrozen bit location of a polar code on the selected number of CCEs; and
perform second decoding of a polar code on the downlink control information encoded on the determined unfrozen bit location.

9. The UE of claim 8, wherein, if the selected minimum number is 1, the frozen bit location and the unfrozen bit location of the polar code on the one CCE are determined, and if the decoding fails and two CCEs, which is larger than the minimum number, 1, are selected, the frozen bit locations and the unfrozen bit locations of the polar code on the two CCEs are determined.

10. The UE of claim 9, wherein a set of unfrozen bit locations on the two CCEs do not include a set of unfrozen bit locations on the one CCE.

11. The UE of claim 8, wherein the processor is further configured to perform a parity check on a result of performing the first decoding by using a result of performing the second decoding.

12. The UE of claim 8, wherein the processor is further configured to combine a result of performing the first decoding and a result of performing the second decoding according to a Log-Likelihood Ratio (LLR) scheme.
